(19) United States
(12) Patent Application Publication
(10) Pub. No.: US 2012/0275349 A1
(43) Pub. Date: Nov. 1, 2012

(54) CONFERENCE CALL MONITORING WITH AUTOMATIC RECONNECT

(75) Inventors: Marc Boyer, Seattle, WA (US); Arulkumar Elumalai, Lynnwood, WA (US)

(73) Assignee: Microsoft Corporation, Redmond, WA (US)

(21) Appl. No.: 13/094,848

(22) Filed: Apr. 27, 2011

(51) Int. Cl. H04L 12/18

(52) U.S. Cl. 370/261

(57) ABSTRACT

Technologies are described herein for monitoring a participant's connection to a conference and automatically reconnecting the participant if the participant is inadvertently disconnected. A conference proxy module receives a request from a participant identifying a conference to join and an endpoint of the participant to connect to the conference. Upon receiving the request, the conference proxy module joins the conference on behalf of the participant and instructs the conferencing service to establish a connection with the identified endpoint. The conference proxy module then monitors the status of the connection with the participant's endpoint, and if the endpoint is unintentionally disconnected, the conference proxy module instructs the conferencing service to reconnect the endpoint to the conference.

### BACKGROUND

Web-based conferencing allows remote conference participants to participate in live meetings, training, or presentations in real-time. A conferencing service may provide several communication methods, or “channels,” for participants to communicate within a conference. For example, a participant may participate in an audio portion of the conference via the telephone, while viewing a presentation or other shared data on their computer. Joining the conference may involve dialing a specific telephone number on the participant's telephone and entering a conference ID, navigating to a specific URL in the participant's Web browser and typing a passcode, and the like. The participant may receive a meeting invitation e-mail containing the telephone number, URL, conference ID, passcode, and/or other conferencing information, for example.

However, depending on the participant's location and method of connecting to the conference, joining the conference may not be easy, especially when joining from a cellular phone or other mobile device, where the participant may have to remember the telephone number and conference ID from the invitation in order to dial-in to the audio portion on the phone. If the participant is inadvertently disconnected or “dropped” from the conference, the participant may be required to repeat the steps of locating the meeting invitation e-mail, remembering the telephone number and conference ID, dialing the telephone, entering the conference ID, and the like, in order to re-join the conference. In addition, any important information or conversations that took place during the period of time that the participant was disconnected may be missed by the participant.

It is with respect to these considerations and others that the disclosure made herein is presented.

### SUMMARY

Technologies are described herein for monitoring a participant's connection to a conference and automatically reconnecting the participant if the participant is inadvertently disconnected. Utilizing the technologies described herein, a conference proxy module or other service may be implemented that monitors the status of the connection(s) between a conferencing service and one or more user devices, or “endpoints,” of a participant. If an endpoint is inadvertently disconnected, the conference proxy module instructs the conferencing service to reconnect the endpoint to the conference, thus preventing the participant from having to repeat the steps of locating the meeting invitation e-mail, remembering the telephone number and conference ID, dialing the telephone, entering the conference ID, and the like, in order to re-join the conference.

According to embodiments, a participant may send a request to join a particular conference to the conference proxy module. The request may identify the conference to join as well as the endpoint of the participant to connect to the conference. Upon receiving the request, the conference proxy module joins the conference on behalf of the participant and instructs the conferencing service to establish a connection with the identified endpoint. The conference proxy module then monitors the status of the connection with the participant's endpoint, and if the endpoint is disconnected, the conference proxy module determines if the disconnection was unintentional. If the endpoint was unintentionally disconnected, the conference proxy module then instructs the conferencing service to reconnect the endpoint to the conference.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and several software components provided by the embodiments presented herein;

FIGS. 2 and 3 are block diagrams showing sequences of events involved in establishing an initial connection to a conferencing service for a participant and automatically reconnecting the participant if the participant is inadvertently disconnected, according to embodiments described herein;

FIG. 4 is a flow diagram showing methods for monitoring a participant's connection to a conferencing service and automatically reconnecting the participant if the participant is inadvertently disconnected, according to embodiments described herein; and

FIG. 5 is a block diagram showing an illustrative computer hardware and software architecture for a computing system capable of implementing aspects of the embodiments presented herein.

### DETAILED DESCRIPTION

The following detailed description is directed to technologies for monitoring a participant's connection to a conferencing service and automatically reconnecting the participant if the participant is inadvertently disconnected. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof and that show, by way of illustration, specific embodiments or examples. In the accompanying drawings, like numerals represent like elements through the several figures.

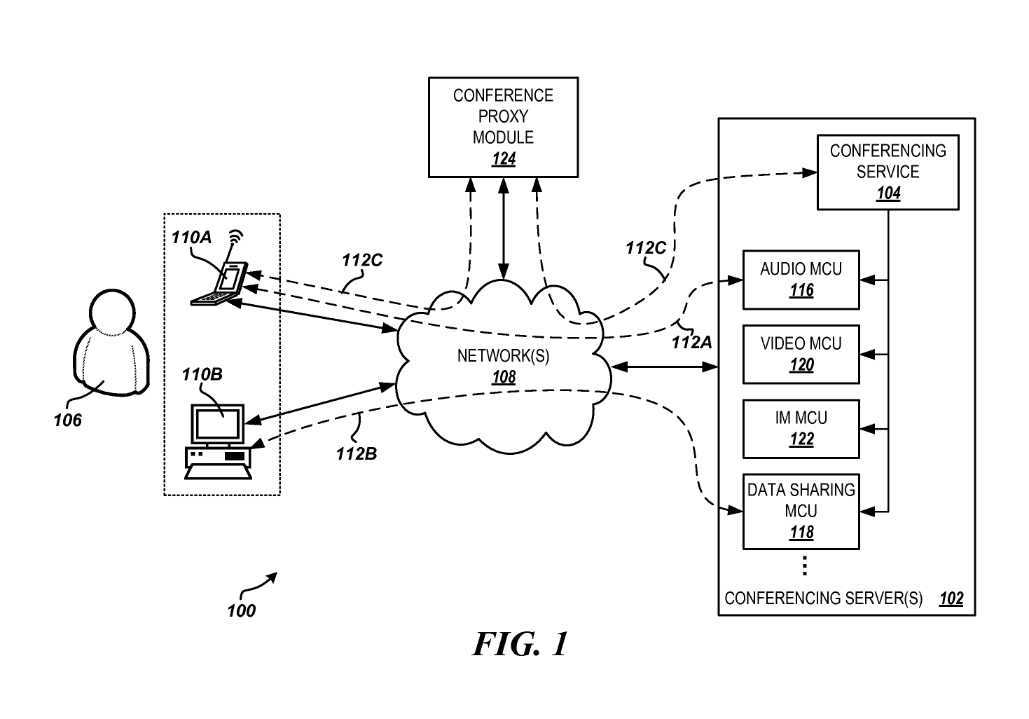

FIG. 1 shows an illustrative operating environment 100 including several software components for monitoring a participant's connection to a conferencing service and automatically reconnecting the participant if the participant is inadvertently disconnected, according to embodiments provided herein. The environment 100 includes one or more conferencing servers 102. The conferencing server(s) 102 may be conventional server computers, network appliances, special-purpose computing devices, other computing devices capable of executing application programs, or any combination thereof.

According to embodiments, a conferencing service 104 executes on the conferencing server(s) 102. The conferencing service 104 provides conferencing services to participants 106 over one or more networks 108. The conferencing service 104 may be a component of a communication or collaboration software application, such as the MICROSOFT® OFFICE COMMUNICATIONS SERVER from MICROSOFT Corporation of Redmond, Wash., the IBM® LOTUS® DOMINO® collaborations software from INTERNATIONAL BUSINESS MACHINES CORP. of Armonk, N.Y., or other conferencing, communication, and collaboration server platform or technologies. The conferencing service 104 may execute on a single conferencing server 102 or in parallel across multiple conferencing servers. In addition, the conferencing service 104 may consist of a number of modules and subcomponents executing on different conferencing servers 102 or other computing devices. The conferencing service 104 may be implemented as software, hardware, or any combination of the two.

The network(s) 108 connect the conferencing server(s) 102 to one or more user devices, or “endpoints” 110A, 110B (referred to herein generally as endpoint 110) that allow the participant 106 to participate in conferences hosted by the conferencing service 104. As describe above, the conferencing service 104 may provide multiple communication channels 112A-112C (referred to herein generally as channel 112) for a participant 106 to connect to a web conference from various endpoints 110 of the participant. For example, the participant 106 may utilize an audio endpoint 110A, such as a telephone, cellphone, VoIP phone, or the like, to establish an audio channel 112A with the conferencing server(s) 102.

Alternatively or at the same time, the participant may use a computing device endpoint 110B, such as a desktop personal computer (“PC”), a laptop, a notebook, a personal digital assistant (“PDA”), a smartphone, a game console, a set-top box, a consumer electronics device, or the like, to establish a data-sharing channel 112B with the conferencing server(s) 102. It will be appreciated that two or more logical endpoints 110 may be embodied on one physical device. For example, the participant 106 may utilize a smartphone device that executes a client application that facilitates the smartphone acting as a computing device endpoint 110B for viewing shared data over the data-sharing channel 112B, while simultaneously utilizing the phone capabilities of the smartphone as an audio endpoint 110A to participate in the audio portion of the conference over the audio channel 112A.

The network(s) 108 support the various communication methods required by the different communication channels 112. For example, the network(s) 108 may include the Public Switched Telephone Network (“PSTN”), cellular telephone networks, local-area networks (“LANs”), wide-area networks (“WANs”), the Internet, or any other networking topology that connects the conferencing server(s) 102 to the various endpoints 110 of the participants 106.

In some embodiments, the conferencing service 104 may utilize one or more multipoint control units (“MCU”) executing on the conferencing server(s) 102 to handle communication with connected endpoints 110 over a particular type of communication channel 112 in a conference. For example, an audio MCU 116 may handle the audio channels 112A established with multiple audio endpoints 110A, mixing the signals received from each audio endpoint, and sending the combined signals back to all connected audio endpoints in the conference. Similarly, a data-sharing MCU 118 may facilitate the sharing of the desktop of a computing device endpoint 110B of one participant 106 in the conference with the computing device endpoints of other conference participants. It will be appreciated that the conferencing server(s) 102 may implement other types of MCUs to facilitate other types of communication channels 112 and endpoints 110 for participants 106 of a conference, including, but not limited to, a video MCU 120 for sharing real-time video images of participants and an Internet Messaging (“IM”) MCU 122 facilitating an IM discussion during the conference presentation.

In addition, the conferencing service 104 may maintain an administrative data channel 112C with one or more of the endpoints 110 of each participant 106 in the conference. The administrative data channel 112C may provide status information regarding the conference call to the connected endpoint 110, such as the names and locations of the connected participants 106, the identity of the current speaker on the audio channel 112A, the identity of the participant who is currently sharing the desktop over the data-sharing channel 112B, notifications of the joining of a participant 106, notifications of the disconnection of a participant, and the like. The administrative data channel 112C may also facilitate changes to the conference initiated by the participant 106 through the connected endpoint 110, such as adding a new participant, establishing an audio channel 112A with an audio endpoint of a participant, locking the conference from any additional connections or participants, terminating the conference, and the like.

The participant 106 may utilize a client application executing on the endpoint 110 connected to the conferencing service 104 via the administrative data channel 112C that allows the participant to view the status information regarding the conference as well as initiate changes to the conference. For example, the connected endpoint 110 may execute a conferencing application that utilizes a conferencing protocol, such as the Centralized Conferencing Control Protocol (“C3P”), to communicate with the conferencing service 104. The conferencing protocol may facilitate the exchange of status information and/or the initiation of changes to the conference over the administrative data channel 112C. In another example, the endpoint 110 may utilize a Web browser application to view the status of the conference and otherwise communicate with the conferencing service 104 over the administrative data channel 112C. A Web service (not shown) may execute on or in conjunction with the conferencing server(s) 102 to facilitate the communication between the Web browser application executing on the endpoint 110 and the conferencing service 104 executing on the conferencing server(s) 102.

According to embodiments, the environment 100 also includes a conference proxy module 124. As will be described below, the conference proxy module 124 monitors the status of the conference and one or more connections of a participant's endpoint(s) 110. Further, in the event that an endpoint 110 is inadvertently disconnected, the conference proxy module 124 detects the disconnection and instructs the conferencing service 104 to reconnect the endpoint to the conference, preventing the participant 106 from having to repeat the steps of locating the meeting invitation e-mail, remembering the telephone number and conference ID, dialing the telephone, entering the conference ID, and the like, in order to re-join the conference. The conference proxy module 124 may also ensure that the communications that take place in the conference during the disconnected period are recorded, allowing the participant 106 to replay what was discussed during the disconnection. The conference proxy module 124 may execute on the conferencing server(s) 102, or the conference proxy module may be implemented on one or more server computers, network appliances, and/or special-purpose computing devices connected to the conferencing server(s) by the network(s) 108. The conference proxy module 124 may be implemented as software, hardware, or any combination of the two.

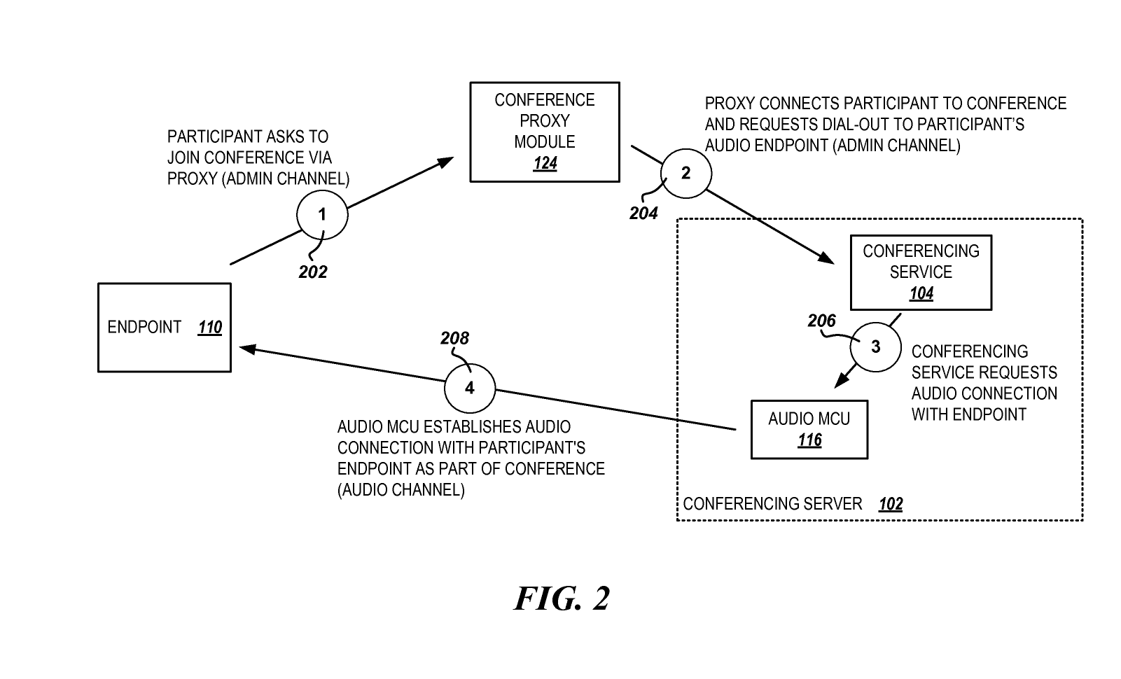

According to one embodiment, the conference proxy module 124 acts as a proxy for a particular endpoint, such as endpoint 110A, of the participant 106 in communicating with the conferencing service 104 over the administrative data channel 112C. As will be described below in regard to FIG. 2, the conference proxy module 124 receives a request to connect to a conference from the endpoint 110A, and in turn establishes a connection with the conferencing service 104 over the administrative data channel 112C, impersonating an endpoint of the participant 106. The conference proxy module 124 may communicate with the requesting endpoint 110A using the same protocol utilized to connect to the conferencing service 104, such as C3P. Alternatively or additionally, the requesting endpoint 110A may run a client application that communicates with the conference proxy module 124 using some other protocol, while the conference proxy module 124 utilizes C3P to communicate with the conferencing service 104 and establish the connection for the participant 106 to the conference. The conference proxy module 124 may also forward conference status information received over the administrative data channel 112C from the conferencing service 104 back to the requesting endpoint 110A for display to the participant 106.

In another embodiment, the conference proxy module 124 may be independently connected to the conferencing service 104 over the administrative data channel 112, and utilize C3P or some other protocol to monitor the connections of one or more endpoints 110 connected to a conference for a number of participants 106. In the event an endpoint 110 is disconnected, the conference proxy module 124 may utilize its connection to the conferencing service 104 to instruct the conferencing service to reconnect the endpoint to the conference and/or to record the communications that occur over the corresponding communication channel 112 during the disconnected period. Other implementations of the conference proxy module 124 beyond those described herein will become apparent to one skilled in the art from a reading of this disclosure and a review of the associated drawings. It is intended that this application include all implementations of the conference proxy module 124.

FIG. 2 shows an exemplary sequence of events and actions that take place during the connection of a participant 106 to a conference, according to one embodiment. As shown at 202, a participant 106 operating an endpoint 110 first sends a request to the conference proxy module 124 to connect to a conference. According to one embodiment, the participant 106 may utilize a client application executing on the requesting endpoint 110 to send the request to the conference proxy module 124. In another embodiment, the request from the endpoint 110 to join a conference via a particular URL, phone number, or other conference address may be intercepted by the conference proxy module 124. The request may include one or more of a conference ID, a passcode, a conferencing service address, an URL, a phone number, or any other information required to identify the conference to which the participant 106 wishes to connect. The request may also include an identification of the participant's endpoint 110, such as a telephone number or IP address, with which to establish the conference connection, along with an indication of the type of communication channel 112 to utilize for the connection to the endpoint.

Next, the conference proxy module 124 uses the conference ID, passcode, and/or other conference address to connect to the conferencing service 104 on behalf of the participant 106, as shown at 204. In one embodiment, the conference proxy module 124 “impersonates” the participant 106 by connecting to conferencing service 104 as an endpoint 110 of the participant over the administrative data channel 112C. The conference proxy module 124 then requests that an appropriate communication channel 112 be established between the conferencing server(s) 102 and the identified endpoint 110 of the participant 106. For example, as further shown at 204 in FIG. 2, the conference proxy module 124 may request that the conferencing service 104 establish an audio channel 112A with the participant's audio endpoint 110A using the specified telephone number. The conference proxy module 124 may utilize a method of C3P, such as the addEndpointMedia method, to instruct the conferencing service 104 to establish the audio connection with the identified audio endpoint 110A.

At 206, the conferencing service 104 instructs the appropriate MCU to establish a connection with the identified endpoint 110. For example, the conferencing service 104 may request that the audio MCU 116 establish an audio channel 112A between the MCU and the identified audio endpoint 110A by dialing the supplied telephone number. Next, at 208, the audio MCU 116 establishes an audio channel 112A with the identified audio endpoint 110A. For example, the audio MCU 116 may utilize the Session Initiation Protocol (“SIP”) to dial-out to the participant's audio endpoint 110A.

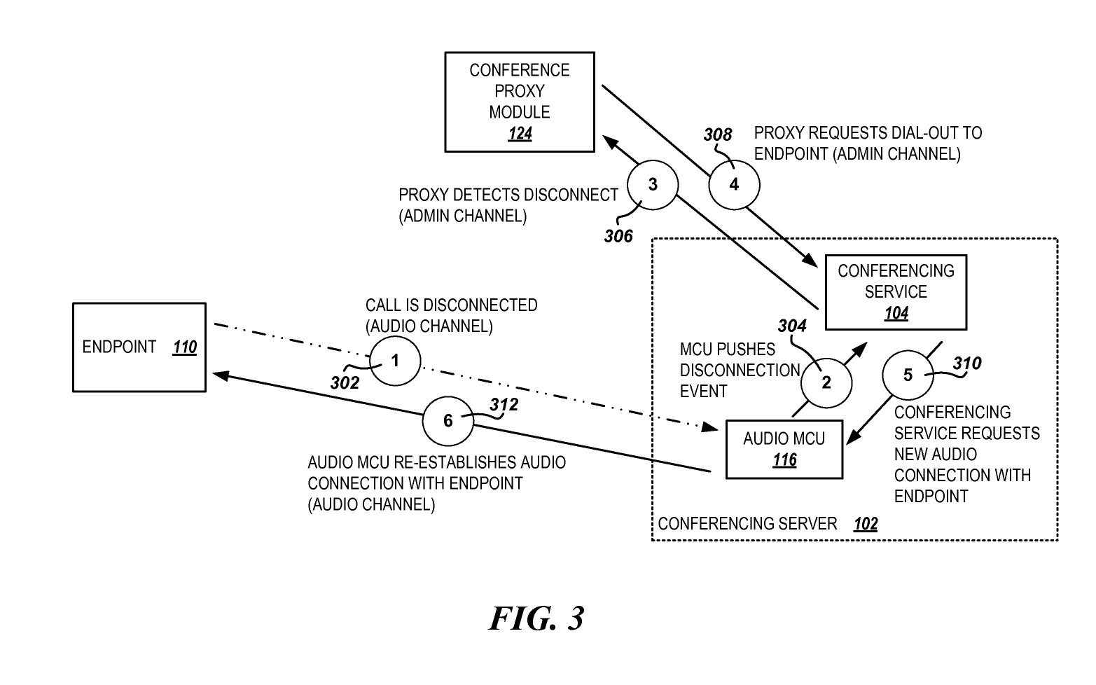

FIG. 3 shows an exemplary sequence of events and actions that take place when an endpoint 110 of a participant is inadvertently disconnected from the conference, according to one embodiment. As shown at 302, the endpoint 110 is disconnected. For example, an audio endpoint 110A comprising a mobile telephone may drop the audio channel 112A established with the audio MCU 116 as the telephone moves out of the coverage area of a cellular telephone network. The audio MCU 116 detects the dropped call and, at 304, pushes the disconnection event for the disconnected endpoint 110 to the conferencing service 104.

Next, the conference proxy module 124 detects that the endpoint 110 has been disconnected from the conference, as shown at 306. For example, since the conference proxy module 124 is acting as an endpoint 110 for the participant 106, as described above in regard to FIG. 2, the conference proxy module may monitor the status of the conference over the administrative data channel 112C. The conference proxy module 124 may utilize C3P to periodically poll the conferencing service 104 to obtain the conference status, including the status of the connection with the endpoint 110, or the conference proxy module may receive a notification of a status change from the conferencing service 104 indicating that the endpoint has been disconnected. Upon detecting the disconnection of the endpoint 110, the conference proxy module 124 makes a request to the conferencing service 104 to re-establish the communication channel 112 with the disconnected endpoint 110 at 308. For example, the conference proxy module 124 may utilize the same method utilized at 204 in FIG. 2 to request that the conferencing service 104 establish an audio channel 112A with the participant's audio endpoint 110A. The conference proxy module 124 may utilize the telephone number or IP address specified in the original request to identify the audio endpoint 110A with which to re-establish the connection.

As shown at 310 in FIG. 3, the conferencing service 104 then instructs the appropriate MCU to establish a new connection with the identified endpoint 110. For example, the conferencing service 104 may request that the audio MCU 116 establish a new audio channel 112A between the MCU and the identified audio endpoint 110A by dialing the supplied telephone number. Next, at 312, the audio MCU 116 establishes an audio channel 112A with the identified audio endpoint 110A, using a similar method to that described above at 208 in FIG. 2, for example.

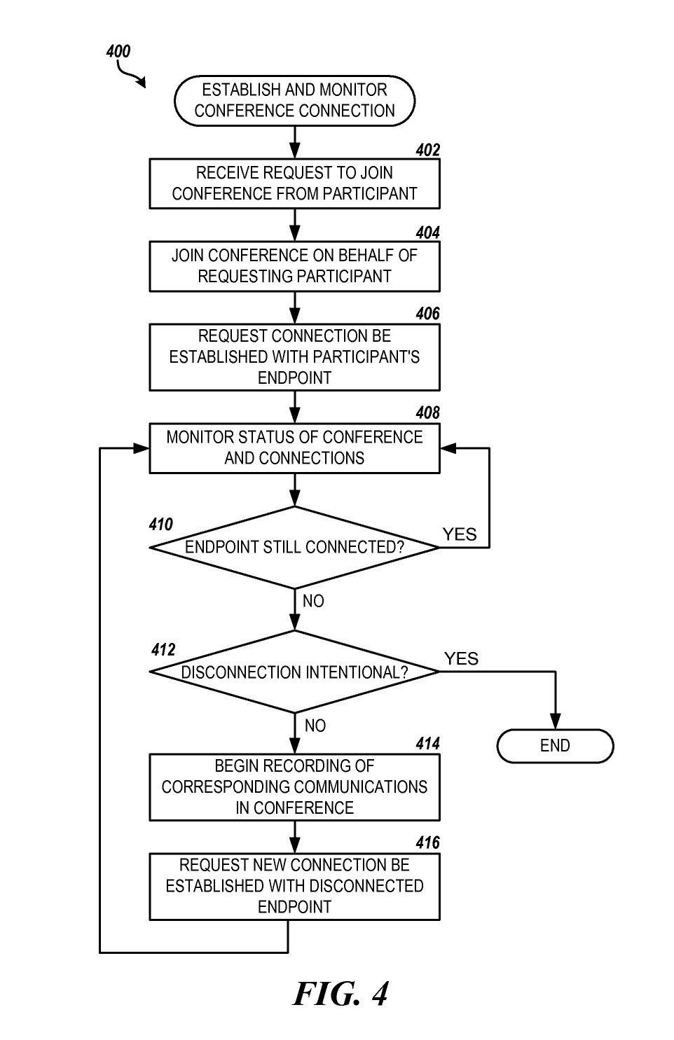

Referring now to FIG. 4, additional details will be provided regarding the embodiments presented herein. It should be appreciated that the logical operations described with respect to FIG. 4 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof It should also be appreciated that more or fewer operations may be performed than shown in the figures and described herein. The operations may also be performed in a different order than described.

FIG. 4 illustrates a routine 400 for establishing a connection to a conference on behalf of a participant 106, monitoring the participant's connection to the conference, and automatically reconnecting the participant if the connection is lost, according to embodiments described herein. According to one embodiment, the routine 400 is performed by the conference proxy module 124 executing on the conferencing server(s) 102 and/or other servers or computing devices. It will be appreciated that the routine 400 may also be performed by other modules or components executing on other computing devices, or by any combination of modules, components, and computing devices.

The routine 400 begins at operation 402, where the conference proxy module 124 receives a request to join a conference hosted by the conferencing service 104 from a participant 106. In one embodiment, the participant 106 may make the request utilizing an application executing on an endpoint 110 of the participant. For example the participant 106 may execute a client application on a mobile phone endpoint 110A that communicates over the network(s) 108 with the conference proxy module 124 to request a connection to the conference. Alternatively, the participant 106 may utilize a Web browser application executing on a computing endpoint 110B to access a Web service hosted by the conference proxy module 124, the conferencing server(s) 102, or other server in order to request a connection to the conference.

The request may include one or more of a conference ID, a passcode, a conferencing service address, an URL, a phone number, or any other information required to identify the conference to which the participant 106 wishes to connect. The request may also include an identification of the participant's endpoint 110, such as a telephone number or IP address, with which to establish the conference connection, along with an indication of the type of communication channel 112 to utilize for the connection to the endpoint. In another embodiment, a request to join a conference from an endpoint 110 of the participant 106 via a particular URL, phone number, or other conference address may be intercepted by the conference proxy module 124. The conference proxy module 124 may determine the conference ID, passcode, conferencing service address, or other information to identify the conference and the identification of the participant's endpoint 110 with which to establish the conference connection from the intercepted request.

From operation 402, the routine 400 proceeds to operation 404, where the conference proxy module 124 joins the conference on behalf of the requesting participant 106. As described above in regard to FIG. 2, the conference proxy module 124 uses the conference ID, passcode, conferencing service address, and/or other information to identify the conferencing service 104 hosting the conference and connects to the conferencing service via the administrative data channel 112C as an endpoint 110 of the participant 106, according to one embodiment.

The routine 400 proceeds from operation 404 to operation 406, where the conference proxy module 124 requests an appropriate communication channel 112 be established between the conferencing service 104 and the participant's endpoint 110 as identified in the request. For example, the conference proxy module 124 may request that the conferencing service 104 establish an audio channel 112A with an audio endpoint 110A of the participant 106 using the specified telephone number, IP address, or other information identifying the audio endpoint. The conference proxy module 124 may utilize a method of C3P, such as the addEndpointMedia method, to instruct the conferencing service 104 to establish the audio connection with the identified audio endpoint 110A.

From operation 408, the routine 400 proceeds to operation 410, where the conference proxy module 124 monitors the status of the conference and the connection to the identified endpoint 110 established on behalf of the participant 106. According to one embodiment, since the conference proxy module 124 is connected to the conferencing service 104 as an endpoint 110 of the participant 106, the conference proxy module 124 may monitor the status of the conference along with the connection of the participant's endpoints via C3P or other protocol over the administrative data channel 112C. The conference proxy module 124 may periodically poll the conferencing service 104 to retrieve the status of the conference and the connections to the participant's endpoint(s) 110, or the conference proxy module may receive notifications of status changes from the conferencing service 104 indicating that an endpoint has been disconnected. In another embodiment, while monitoring the status of the conference, the conference proxy module 124 also forwards conference status information received over the administrative data channel 112C from the conferencing service 104 back to the requesting endpoint 110 for display to the participant 106.

The routine 400 proceeds from operation 408 to operation 410, where the conference proxy module 124 determines if the identified endpoint 110 is still connected to the conferencing service 104. If the endpoint 110 is still connected, the routine 400 returns to operation 408, where the conference proxy module 124 continues to monitor the status of the conference and the connection(s) to the participant's endpoint(s) 110. If, however, the connection to the endpoint 110 is lost, the routine 400 proceeds to operation 412, where the conference proxy module 124 determines if the disconnection was intentional or unintentional.

In one embodiment, the conference proxy module 124 may be able to determine whether the disconnection of the endpoint 110 was intentional or unintentional from the notification that the endpoint was disconnected received from the conferencing service 104 over the administrative data channel 112C. Alternatively or additionally, the conference proxy module 124 may determine whether its data connection with the requesting endpoint 110 of the participant 106 is still available. If so, the conference proxy module 124 may query the participant 106 on the requesting endpoint 110 as to whether the disconnection was intentional and/or whether the participant wishes the connection reestablished. If the conference proxy module 124 determines that the disconnection was intentional, the routine 400 ends.

If the conference proxy module 124 determines that the disconnection was not intentional, the routine 400 proceeds from operation 412 to operation 414, where the conference proxy module 124 requests that conferencing service 104 begin recording the communications in the conference corresponding to the communication channel 112 supporting the disconnected endpoint 110, according to one embodiment. It will be appreciated that the reconnection of the disconnected endpoint 110 may take some period of time. For example, if an audio endpoint 110A comprising a mobile telephone is disconnected due to having moved out of the coverage area of the cellular telephone network, the connection with the audio endpoint may not be reestablished until the mobile telephone returns to the coverage area.

The conference proxy module 124 may ensure that the portion of communications in the conference that take place during the disconnected period is recorded, and make the recording available to the participant 106 for review at a later time. For example, the conference proxy module 124 may utilize C3P over the administrative data channel 112C to request that the conferencing service 104 begin recording the audio portion of the conference through the audio MCU 116 if the connection to an audio endpoint 110A of the participant 106 is lost. Once the connection to the audio endpoint 110A is restored, the conference proxy module 124 may use the same or similar method to stop recording of the audio portion of the conference.

In another embodiment, some or all of the communications through the various communication channels 112 may be recorded in the conference. Upon reconnecting the participant's endpoint 110, or at the end of the conference, the conference proxy module 124 may subsequently make the recorded portion of the communications corresponding to the disconnected period available to the participant 106 for review. For example the conference proxy module 124 may provide a UI to the requesting endpoint 110 at the end of the conference allowing the participant 106 to review the recorded portion. Alternatively or additionally, upon detection of the disconnect and corresponding reconnect of the endpoint 110, the conference proxy module 124 may send an e-mail or other offline communication to the participant 106 including the missed portion of the communication on the communication channel 112 supporting the disconnected endpoint.

From operation 414, the routine proceeds to operation 416, where the conference proxy module 124 requests a new connection be established with the disconnected endpoint 110. The conference proxy module 124 may make a request to the conferencing service 104 to re-establish the communication channel 112 with the disconnected endpoint 110 utilizing the same method used in operation 406. For example, the conference proxy module 124 may utilize a C3P method to request through the administrative data channel 112C that the conferencing service 104 establish a new audio channel 112A with the participant's audio endpoint 110A. The conference proxy module 124 may utilize the telephone number or IP address specified in the original request to identify the audio endpoint 110A with which to re-establish the connection. Upon reconnection of the disconnected endpoint 110, the routine 400 returns to operation 408, where the conference proxy module 124 continues to monitor the status of the conference and the connection(s) to the participant's endpoint(s) 110.

While the present disclosure uses the example of an audio channel 112A connecting an audio endpoint 110A with the conferencing server(s) 102, it will be appreciated that the methods presented herein for monitoring the connection of a participant's endpoint 110 and automatically reconnecting the endpoint if inadvertently disconnected may operate with other types of endpoints and communication channels. For example, the conference proxy module 124 may monitor and automatically reconnect the connection between the conferencing server(s) 102 and a computing endpoint 110B connected via an IM channel, a video channel, a data-sharing channel 112B, and the like. In a further embodiment, the conference proxy module 124 may connect independently to the conferencing service 104 over the administrative data channel 112C and monitor the connections of one or more endpoints 110 connected to a conference for a number of participants 106. The conference proxy module 124 may utilize C3P or some other protocol to monitor the connections of the one or more endpoints 110. In the event an endpoint 110 is disconnected, the conference proxy module 124 may utilize the method described in operations 408 through 416 above to determine if the disconnect was intentional or unintentional, and instruct the conferencing service 104 to reconnect the endpoint 110 to the conference and/or to record the communications that occur over the corresponding communication channel 112 during the disconnected period.

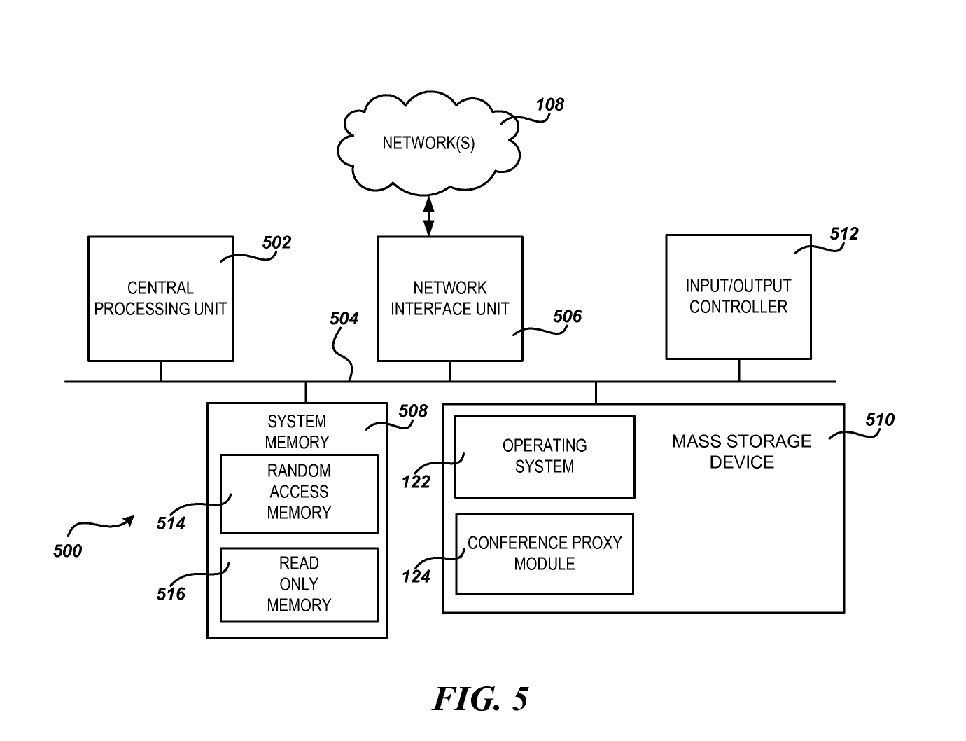

FIG. 5 shows an example computer architecture for a computer 500 capable of executing the software components described herein for monitoring a participant's connection to a conferencing service and automatically reconnecting the participant if the participant is inadvertently disconnected, in the manner presented above. The computer architecture shown in FIG. 5 illustrates a conventional server computer, desktop computer, laptop, notebook, PDA, wireless phone, or other computing device, and may be utilized to execute any aspects of the software components presented herein described as executing on the conferencing server(s) 102 or other computing device.

The computer architecture shown in FIG. 5 includes one or more central processing units (“CPUs”) 502. The CPUs 502 may be standard processors that perform the arithmetic and logical operations necessary for the operation of the computer 500. The CPUs 502 perform the necessary operations by transitioning from one discrete, physical state to the next through the manipulation of switching elements that differentiating between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 508, including a random access memory (“RAM”) 514 and a read-only memory 516 (“ROM”), and a system bus 504 that couples the memory to the CPUs 502. A basic input/output system containing the basic routines that help to transfer information between elements within the computer 500, such as during startup, is stored in the ROM 516. The computer 500 also includes a mass storage device 510 for storing an operating system 122, application programs, and other program modules, which are described in greater detail herein.

The mass storage device 510 is connected to the CPUs 502 through a mass storage controller (not shown) connected to the bus 504. The mass storage device 510 provides non-volatile storage for the computer 500. The computer 500 may store information on the mass storage device 510 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 500 may store information to the mass storage device 510 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 500 may further read information from the mass storage device 510 by detecting the physical states or characteristics of one or more particular locations within the mass storage device.

As mentioned briefly above, a number of program modules and data files may be stored in the mass storage device 510 and RAM 514 of the computer 500, including an operating system 518 suitable for controlling the operation of a computer. The mass storage device 510 and RAM 514 may also store one or more program modules. In particular, the mass storage device 510 and the RAM 514 may store the conference proxy module 124, which was described in detail above in regard to FIG. 1. The mass storage device 510 and the RAM 514 may also store other types of program modules or data.

In addition to the mass storage device 510 described above, the computer 500 may have access to other computer-readable media to store and retrieve information, such as program modules, data structures, or other data. It should be appreciated by those skilled in the art that computer-readable media may be any available media that can be accessed by the computer 500, including computer-readable storage media and communications media. Communications media includes transitory signals. Computer-readable storage media includes volatile and non-volatile, removable and non-removable media implemented in any method or technology for the storage of information, such as computer-readable instructions, data structures, program modules, or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 500.

The computer-readable storage medium may be encoded with computer-executable instructions that, when loaded into the computer 500, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 500 by specifying how the CPUs 502 transition between states, as described above. According to one embodiment, the computer 500 may have access to computer-readable storage media storing computer-executable instructions that, when executed by the computer, perform the routine 400 for monitoring a participant's connection to a conferencing service and automatically reconnecting the participant if the participant is inadvertently disconnected, described above in regard to FIG. 4.

According to various embodiments, the computer 500 may operate in a networked environment using logical connections to remote computing devices and computer systems through one or more network(s) 108, such as a LAN, a WAN, the Internet, or a network of any topology known in the art. The computer 500 may connect to the network(s) 108 through a network interface unit 506 connected to the bus 504. It should be appreciated that the network interface unit 506 may also be utilized to connect to other types of networks and remote computer systems.

The computer 500 may also include an input/output controller 512 for receiving and processing input from a number of input devices, including a keyboard, a mouse, a touchpad, a touch screen, an electronic stylus, or other type of input device. Similarly, the input/output controller 512 may provide output to a display device, such as a computer monitor, a flat-panel display, a digital projector, a printer, a plotter, or other type of output device. It will be appreciated that the computer 500 may not include all of the components shown in FIG. 5, may include other components that are not explicitly shown in FIG. 5, or may utilize an architecture completely different than that shown in FIG. 5.

Based on the foregoing, it should be appreciated that technologies for monitoring a participant's connection to a conferencing service and automatically reconnecting the participant if the participant is inadvertently disconnected are provided herein. Although the subject matter presented herein has been described in language specific to computer structural features, methodological acts, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for automatically reconnecting a disconnected audio endpoint participating in a conference, the method comprising executing instructions in a computer system to perform the operations of:
receiving a request from a participant to join the conference through the audio endpoint;
joining the conference on behalf of the participant;
requesting that an audio channel be established between the audio endpoint and a conferencing server hosting the conference;
monitoring the status of the audio channel established for the audio endpoint;
detecting that the audio endpoint has disconnected;
upon detecting that the audio endpoint has disconnected, determining whether the disconnection was unintentional; and
upon determining that the disconnection was unintentional, requesting that a new audio channel be established between the audio endpoint and the conferencing server.

2. The computer-implemented method of claim 1, wherein joining the conference on behalf of the participant comprises impersonating the participant by connecting as an endpoint for the participant to a conferencing service hosting the conference.

3. The computer-implemented method of claim 1, further comprising requesting that an audio portion of the conference be recorded during a period of disconnection of the audio endpoint, the recorded audio portion being made available to the participant for review subsequent to reconnection of the audio endpoint.

4. The computer-implemented method of claim 1, wherein the request to join the conference is received from a client application executing on a requesting endpoint of the participant, and wherein the request comprises an identifier of the conference to join and an identifier of the audio endpoint to connect.

5. The computer-implemented method of claim 4, wherein determining whether the disconnection was unintentional comprises querying the participant through the requesting endpoint as to whether to reconnect the disconnected audio endpoint.

6. The computer-implemented method of claim 1, wherein the request to join the conference is intercepted and an identifier of the conference to join and an identifier of the audio endpoint to connect are determined from the intercepted request.

7. A computer-readable storage medium encoded with computer-executable instructions that, when executed by a computer, cause the computer to:
connect to a conferencing service hosting a conference;
monitor the status of a connection with an endpoint of a participant in the conference;
detect that the endpoint has disconnected;
upon detecting that the endpoint has disconnected, determine whether the disconnection was unintentional; and
upon determining that the disconnection was unintentional, send a request to the conferencing service to establish a new connection with the endpoint.

8. The computer-readable storage medium of claim 7, wherein connecting to the conferencing service comprises impersonating an endpoint of the participant.

9. The computer-readable storage medium of claim 7, wherein monitoring the status of the connection with the endpoint comprises periodically polling the conferencing service for a status of the conference.

10. The computer-readable storage medium of claim 7, wherein sending the request to the conferencing service to establish the new connection with the endpoint comprises using a method of the Centralized Conferencing Control Protocol.

11. The computer-readable storage medium of claim 7, wherein the endpoint comprises a telephone and wherein the request sent to the conferencing service to establish the new connection with the endpoint comprises a telephone number to be called to connect the telephone.

12. The computer-readable storage medium of claim 7, encoded with further computer-executable instructions that cause the computer to, upon detecting that the endpoint has disconnected, request that a portion of a communication channel of the conference supporting the connection to the endpoint be recorded during a period of disconnection of the endpoint, the recorded portion being made available to the participant for review.

13. The computer-readable storage medium of claim 7, encoded with further computer-executable instructions that cause the computer to:
receive a request from the participant to join the conference, wherein the request identifies the endpoint; and
send a request to the conferencing service to establish an initial connection with the endpoint.

14. The computer-readable storage medium of claim 13, wherein the request to join the conference is received from a client application executing on a requesting endpoint of the participant, and wherein the request comprises an identifier of the conference to join.

15. The computer-readable storage medium of claim 14, wherein determining whether the disconnection was unintentional comprises querying the participant through the requesting endpoint as to whether to reconnect the disconnected endpoint.

16. A system for monitoring a connection of a first endpoint of a participant to a conference and reconnecting the first endpoint if inadvertently disconnected, the system comprising:
a computer; and
a conference proxy module executing on the computer and configured to
receive a request from the participant to join the conference, wherein the request identifies the first endpoint,
connect to a conferencing service hosting the conference as a second endpoint of the participant,
send a request to the conferencing service to establish a connection with the first endpoint,
monitor the status of the connection with the first endpoint,
detect that the first endpoint has disconnected, and
upon detecting that the first endpoint has disconnected, send a request to the conferencing service to establish a new connection with the first endpoint.

17. The system of claim 16, further comprising a client application executing on a requesting endpoint of the participant and configured to send the request to join the conference to the conference proxy module, and wherein the conference proxy module is further configured to forward status information received from the conferencing service to the client application for display to the participant.

18. The system of claim 17, wherein the conference proxy module is further configured to:
upon detecting that the first endpoint has disconnected, determine if a connection with the client application is still available; and
upon determining that the connection with the client application is available, query the participant through the client application as to whether to reconnect the disconnected first endpoint.

19. The system of claim 17, wherein the first endpoint and the requesting endpoint are a same user device.

20. The system of claim 16, wherein the first endpoint comprises a telephone and wherein the request sent to the conferencing service to establish the connection with the first endpoint comprises a telephone number to be called to connect the telephone.
